(19) United States
(12) Patent Application Publication
(10) Pub. No.: US 2016/0216591 A1
(43) Pub. Date: Jul. 28, 2016

(54) OPTICAL MODULATION DEVICE AND DRIVING METHOD THEREOF

(71) Applicant: SAMSUNG DISPLAY CO., LTD., Yongin-Si (KR)

(72) Inventors: Hyun Seung SEO, Anyang-Si (KR); Seung Jun JEONG, Hwaseong-Si (KR)

(21) Appl. No.: 14/883,491

(22) Filed: Oct. 14, 2015

(30) Foreign Application Priority Data
Jan. 28, 2015 (KR) 10-2015-0013809

(51) Int. Cl. G02F 1/29; G02F 1/133

(52) U.S. Cl. CPC G02F 1/29; G02F 1/13306

(57) ABSTRACT

An optical modulation device includes a first panel that includes a plurality of lower-panel electrodes, a second panel facing the first panel and that includes at least one upper-panel electrode, and a liquid crystal layer positioned between the first panel and the second panel. A method of driving the optical modulation device includes applying a voltage to the upper-panel electrode; forming a forward phase slope by applying a first driving signal to at least one lower-panel electrode corresponding to a first region; forming a backward phase slope by applying a second driving signal different from the first driving signal to at least one lower-panel electrode corresponding to a second region; and forming a flat phase slope by applying a third driving signal different from the first and second driving signals to at least one lower-panel electrode corresponding to a third region between the first and second regions.

### CROSS-REFERENCE TO RELATED APPLICATION

This application claims priority under 35 U.S.C. §119 from Korean Patent Application No. 10-2015-0013809 filed in the Korean Intellectual Property Office on Jan. 28, 2015, and all the benefits accruing therefrom, the contents of which are herein incorporated by reference in their entirety.

### BACKGROUND

(a) Technical Field

Embodiments of the present disclosure are directed to an optical modulation device and a driving method thereof, and more particularly, to an optical modulation device that includes a liquid crystal, a driving method thereof, and an optical device using the same.

(b) Discussion of the Related Art

Recently, an optical device that uses an optical modulation device to modulate light characteristics has been developed. Examples of such optical modulation devices include an optical display device capable of displaying a 3D image, and an optical modulation device that divides and transmits an image at different views to allow a viewer to perceive the image as a 3D image. An optical modulation device that may be used in an autostereoscopic 3D image display device may include a lens, a prism, etc., which change a light path of an image in the display device to transmit the light to a desired view.

As such, to change a direction of incident light, light diffraction ht through phase modulation may be used.

When polarized light passes through an optical modulation device such as a phase retarder, a polarization state changes. For example, when circularly-polarized light is incident to a half-wave plate, a rotation direction of the circularly-polarized light is reversed before the light is emitted. For example, when right circularly-polarized light passes through a half-wave plate, left circularly-polarized light is emitted. In this case, a phase of the emitted circularly-polarized light varies according to an angle of an optical axis of the half-wavelength plate, that is, a slow axis. In detail, when the optical axis of the half-wavelength plate rotates by φ in-plane, the phase of the emitted light is changed by 2φ. Accordingly, when the optical axis of a half-wavelength plate rotates by 180° (π radian) in an x-axial direction in space, the emitted light has a phase modulation or a phase change of 360° (π radian) in the x-axis direction. As such, an optical modulation device that can cause a phase change of 0 to 2π according to a position may be used to implement a diffraction grid or a prism in which the direction of the passed light may be changed or bent.

To control the optical axis of an optical modulation device according to position, a liquid crystal may be used. In an optical modulation device implemented as a phase retarder using liquid crystal, long axes of the liquid crystal molecules aligned by applying an electric field rotate to change the phase modulation according to a position. The phase of the light passing through the optical modulation device may be determined according to an alignment direction of a long axis of the liquid crystal, that is, an azimuthal angle.

### SUMMARY

According to embodiments of the disclosure, to implement a prism, a diffraction grid, a lens, etc., by continuously modulating a phase using an optical modulation device using a liquid crystal layer, the liquid crystal molecules should align so that long axes of the liquid crystal molecules may change continuously according to a position. For a half-wavelength plate, an optical axis thereof should change from 0 to π to have a phase profile in which emitted light changes from 0 to 2π according to a position. This may be accomplished by an alignment process in different directions according to a position with respect to a substrate adjacent to the liquid crystal layer. Further, when the alignment needs to be minutely divided, an aligning process such as a rubbing process may not be uniformly performed and as a result, the aligning process may exhibit display defects.

Therefore, embodiments of the present disclosure can provide an optical modulation device that includes a liquid crystal that can modulate an optical phase by controlling an in-plane rotation angle of the liquid crystal molecules and forming various diffraction angles of light by controlling the rotation direction of the liquid crystal molecules.

Further, embodiments of the present disclosure can provide an optical modulation device that includes a liquid crystal that has a simpler manufacturing process.

Further, embodiments of the present disclosure can provide an optical modulation device that ca smoothly connect a left forward phase slope and a right backward phase slope based on a center of a lens.

Further, embodiments of the present disclosure can provide an optical modulation device that includes a liquid crystal that can be enlarged and can function as a lens to be used in various optical devices such as a 3D image display device.

An exemplary embodiment provides a driving method of an optical modulation device that includes a first panel that includes a plurality of lower-panel electrodes, a second panel facing the first panel and that includes at least one upper-panel electrode, and a liquid crystal layer positioned between the first panel and the second panel. The method includes applying a voltage to the upper-panel electrode; forming a forward phase slope by applying a first driving signal to at least one lower-panel electrode corresponding to a first region; forming a backward phase slope by applying a second driving signal different from the first driving signal to at least one lower-panel electrode corresponding to a second region; and forming a flat phase slope by applying a third driving signal different from the first driving signal and the second driving signal to at least one lower-panel electrode corresponding to a third region between the first region and the second region.

When the first driving signal is applied to at least one lower-panel electrode corresponding to the first region, an absolute value of a first voltage applied to a lower-panel electrode in a first unit in the first region may be less than an absolute value of a second voltage applied to a lower-panel electrode in a second unit adjacent to the first unit, and a polarity of the first voltage applied to the lower-panel electrode of the first unit is the same as the polarity of the second voltage applied to the lower-panel electrode in the second unit.

Forming the backward phase slope in the second region may include applying the first driving signal to the at least one lower-panel electrode corresponding to the second region, applying the second driving signal after a first time period elapses to the at least one lower-panel electrode corresponding to the second region, and applying a fourth driving signal after a second time period elapses.

When the second driving signal is applied to at least one lower-panel electrode corresponding to the second region, a third voltage applied to the lower-panel electrode in a first unit in the second region may have a polarity opposite to a polarity of a fourth voltage applied to the lower-panel electrode in a second unit adjacent to the first unit.

When the fourth driving signal is applied to at least one lower-panel electrode corresponding to the second region, an absolute value of a fifth voltage applied to the lower-panel electrode in the first unit may be greater than an absolute value of a sixth voltage applied to the lower-panel electrode in the second unit.

Forming the flat phase slope in the third region may include applying the first driving signal to at least one lower-panel electrode corresponding to the first region, applying the second driving signal after a first time period elapses to at least one lower-panel electrode corresponding to the second region, applying the fourth driving signal after a second time period elapses to at least one lower-panel electrode corresponding to the third region, and applying the third driving signal after a third time period elapses to at least one lower-panel electrode corresponding to the third region and applying a fifth driving signal after a fourth time period elapses.

The third region may include a first unit, a second unit adjacent to the first unit, and a third unit adjacent to the second unit, and when the fourth driving signal is applied to at least one lower-panel electrode corresponding to the third region, a first voltage applied to the lower-panel electrode in the first unit may be greater than a second voltage applied to the lower-panel electrode in the second unit and a third voltage applied to the lower-panel electrode in the third unit.

When the fourth driving signal is applied to the at least one lower-panel electrode corresponding to the third region, polarities the first voltage, the second voltage, and the third voltage applied to the lower panel electrodes may be the same as each other.

When the third driving signal is applied to the at least one lower-panel electrode corresponding to the third region, an absolute value of a fourth voltage applied to the lower-panel electrode in the third unit may be less than an absolute value of a fifth voltage applied to the lower-panel electrode in the first unit and an absolute value of a sixth voltage applied to the lower-panel electrode in the second unit, the absolute value of the sixth voltage may be less than the absolute value of the fifth voltage, and the absolute value of the fifth voltage may be greater than the absolute value of the first voltage.

When the fifth driving signal is applied to the at least one lower-panel electrode corresponding to the third region, an absolute value of a seventh voltage applied to the lower-panel electrode in the third unit may be less than the absolute value of the sixth voltage, and an absolute value of an eighth voltage applied to the lower-panel electrode adjacent to the lower-panel electrode in the third unit in the first region may be less than the absolute value of the seventh voltage.

Another exemplary embodiment provides an optical modulation device, including a first panel that includes a plurality of lower-panel electrodes and a first alignment director; a second panel facing the first panel and that includes at least one upper-panel electrode and a second alignment director; and a liquid crystal layer positioned between the first panel and the second panel and that includes a plurality of liquid crystal molecules, in which an alignment direction of the first alignment director and an alignment direction of the second alignment director are substantially parallel to each other, wherein when a voltage is applied to the upper-panel electrode, a forward phase slope is formed by applying a first driving signal to at least one lower-panel electrode corresponding to a first region, a backward phase slope is formed by applying a second driving signal different from the first driving signal to at least one lower-panel electrode corresponding to a second region, and a flat phase slope is formed by applying a third driving signal different from the first driving signal and the second driving signal to at least one lower-panel electrode corresponding to a third region between the first region and the second region.

An absolute value of a first voltage applied to the lower-panel electrode in a first unit in the first region may be less than an absolute value of a second voltage applied to the lower-panel electrode in a second unit adjacent to the first unit.

The second region may receive a second driving signal after a first time period elapses after receiving the first driving signal and receive a fourth driving signal after a second time period elapses after receiving the second driving signal to form the backward phase slope.

The third region may receive the second driving signal after a first time period elapses after receiving the first driving signal and may receive a fourth driving signal after a second time period elapses after receiving the second driving signal, and the third region may receive the third driving signal after a third time period elapses after receiving the fourth driving signal and may receive a fifth driving signal after a fourth time period elapses after receiving the third driving signal to form the flat phase slope.

The third region may include a first unit, a second unit adjacent to the first unit, and a third unit adjacent to the second unit, and when the third region receives the third driving signal, an absolute value of a fourth voltage applied to the lower-panel electrode in the third unit may be less than an absolute value of a fifth voltage applied to the lower-panel electrode in the first unit and an absolute value of a sixth voltage applied to the lower-panel electrode in the second unit.

When the third region receives the fifth driving signal, an absolute value of a seventh voltage applied to the lower-panel electrode in the third unit may be less than the absolute value of the sixth voltage.

Another exemplary embodiment provides a driving method of an optical modulation device, wherein the optical modulation device includes a first panel that includes a plurality of lower-panel electrodes, a second panel facing the first panel and that includes at least one upper-panel electrode, and a liquid crystal layer positioned between the first panel and the second panel. The method includes applying a voltage to the upper-panel electrode; and forming a flat phase slope in to at least one lower-panel electrode corresponding to a third region between a first region and a second region by applying a first driving signal to at least one lower-panel electrode corresponding to the first region, applying a second driving signal after a first time period elapses to at least one lower-panel electrode corresponding to the second region, applying a fourth driving signal after a second time period elapses to at least one lower-panel electrode corresponding to the second region, applying the third driving signal after a third time period elapses to at least one lower-panel electrode corresponding to the third region; and applying a fifth driving signal when a fourth time elapses.

The driving method may further include forming a forward phase slope by applying a first driving signal to at least one lower-panel electrode corresponding to the first region; and forming a backward phase slope in at least one lower-panel electrode corresponding to the second region by applying the first driving signal to the at least one lower-panel electrode corresponding to the second region, applying the second driving signal after a first time period elapses to the at least one lower-panel electrode corresponding to the second region, and applying a fourth driving signal after a second time period elapses.

When the second driving signal is applied to the at least one lower-panel electrode corresponding to the second region, a voltage applied to the lower-panel electrode included in a first unit included in the second region may have a polarity opposite to a polarity of a voltage applied to the lower-panel electrode included in a second unit adjacent to the first unit. When the fourth driving signal is applied to the at least one lower-panel electrode corresponding to the second region, an absolute value of a fifth voltage applied to the lower-panel electrode in the first unit may be greater than an absolute value of a sixth voltage applied to the lower-panel electrode in the second unit.

The third region may include a first unit, a second unit adjacent to the first unit, and a third unit adjacent to the second unit. When the fourth driving signal is applied to at least one lower-panel electrode corresponding to the third region, a first voltage applied to the lower-panel electrode included in the first unit may be greater than a second voltage applied to the lower-panel electrode included in the second unit and a third voltage applied to the lower-panel electrode included in the third unit.

An optical modulation device according to the exemplary embodiment can modulate an optical phase by controlling an in-plane rotation angle of liquid crystal molecules and form various diffraction angles for light by controlling a rotation direction of the liquid crystal molecules.

Embodiments of the present disclosure can simplify a manufacturing process of an optical modulation device that includes a liquid crystal, reduce a manufacturing time, and remove defects due to a pretilt distribution of liquid crystal molecules.

Embodiments of the present disclosure can suppress texture by reinforcing a control force for the liquid crystal molecules to enhance diffraction efficiency.

An optical modulation device that includes a liquid crystal may be easily enlarged and may function as a lens, a diffraction grid, a prism, etc., to be used in various optical devices such as a 3D image display device.

Further, embodiments of the present disclosure can smoothly connect a left forward phase slope and a right backward phase slope based on the center of a lens by flatly forming a lens center phase of the optical modulation device.

### BRIEF DESCRIPTION OF THE DRAWINGS

FIG. 1 is a perspective view of an optical modulation device according to an exemplary embodiment.

FIG. 2 is a plan view of alignment directions in a first panel and a second panel included in an optical modulation device according to an exemplary embodiment.

FIG. 3 illustrates a process of assembling the first panel and the second panel illustrated in FIG. 2.

FIG. 4 is a perspective view of alignment of liquid crystal molecules when no voltage difference is applied to a first panel and a second panel of an optical modulation device according to an exemplary embodiment.

FIG. 5 is a cross-sectional view of an optical modulation device illustrated in FIG. 4 taken along lines I, II, and III.

FIG. 6 is a perspective view of alignment of liquid crystal molecules when a voltage difference is applied to a first panel and a second panel of an optical modulation device according to an exemplary embodiment.

FIG. 7 is a cross-sectional view of an optical modulation device illustrated in FIG. 6 taken along lines I, II, and III.

FIG. 8 is a perspective view of an optical modulation device according to an exemplary embodiment.

FIG. 9 is a timing diagram of a driving signal of an optical modulation device according to an exemplary embodiment.

FIG. 10 is a cross-sectional view of FIG. 8 taken along line IV, of alignment of the liquid crystal molecules before a voltage difference is applied to a first panel and a second panel of an optical modulation device according to an exemplary embodiment and after a driving signal is applied in a first step.

FIG. 11 is a cross-sectional view of FIG. 8 taken along line V of alignment of the liquid crystal molecules, and a graph of a phase change corresponding to the alignment, in which alignment is stabilized after a driving signal is applied in a first step in an optical modulation device according to an exemplary embodiment.

FIG. 12 illustrates alignment of liquid crystal molecules in which alignment is stabilized after a driving signal is applied in a first step in an optical modulation device according to an exemplary embodiment.

FIG. 13 is a cross-sectional view taken along line VI of FIG. 8 and a cross-sectional view taken along line VII of alignment of liquid crystal molecules before a voltage difference is applied to the first panel and the second panel of an optical modulation device according to an exemplary embodiment.

FIG. 14 is a cross-sectional view taken along line VI of FIG. 8 of alignment of liquid crystal molecules immediately after a driving signal in is applied a first step in an optical modulation device according to an exemplary embodiment.

FIG. 15 is a cross-sectional view taken along line VI of FIG. 8 of alignment of liquid crystal molecules before alignment is stabilized after a driving signal is applied in a first step in an optical modulation device according to an exemplary embodiment.

FIG. 16 is a cross-sectional view taken along line IV of FIG. 8 and a cross-sectional view taken along line VII of alignment of liquid crystal molecules stabilized after a driving signal is applied in a first step in an optical modulation device according to an exemplary embodiment.

FIG. 17 is a cross-sectional view of FIG. 8 taken along line VI of alignment of liquid crystal molecules before a voltage difference is applied to the first panel and the second panel of an optical modulation device according to an exemplary embodiment and after driving signals are applied in first to third steps, respectively.

FIGS. 18 and 19 are cross-sectional views taken along line VII of FIG. 8 of alignment of liquid crystal molecules stabilized after driving signals are sequentially applied in first to third steps in an optical modulation device according to an exemplary embodiment.

FIG. 20 is a cross-sectional view taken along line VIII of FIG. 8 and a cross-sectional view taken along line IX of alignment of liquid crystal molecules that have stabilized after a driving signal is applied in a third step.

FIG. 21 is a cross-sectional view taken along line VIII of FIG. 8 and a cross-sectional view taken along line IX of alignment of liquid crystal molecules that have stabilized after a driving signal is applied in a fourth step.

FIG. 22 is a cross-sectional view taken along line VIII of FIG. 8 and a cross-sectional view taken along line IX of alignment of liquid crystal molecules that have stabilized after a driving signal is applied in a fifth step.

FIG. 23 is a graph of a simulation of a phase change according to a position of light passing through an optical modulation device according to an exemplary embodiment.

FIG. 24 illustrates a phase change as a function of a lens position implemented using an optical modulation device according to the exemplary embodiment.

FIGS. 25 and 26 illustrate a schematic structure of a 3D image display device as an example of an optical device using an optical modulation device according to an exemplary embodiment and a method of displaying a 2D image and a 3D image, respectively.

### DETAILED DESCRIPTION OF EXEMPLARY EMBODIMENTS

Embodiments of the present disclosure will be described more fully hereinafter with reference to the accompanying drawings, in which exemplary embodiments are illustrated. As those skilled in the art would realize, the described embodiments may be modified in various different ways, all without departing from the spirit or scope of the present disclosure.

In the drawings, the thicknesses of layers, films, panels, regions, and the like, may exaggerated for clarity. Like reference numerals may designate like elements throughout the specification. It will be understood that when an element such as a layer, film, region, or substrate is referred to as being “on” another element, it can be directly on the other element or intervening elements may also be present.

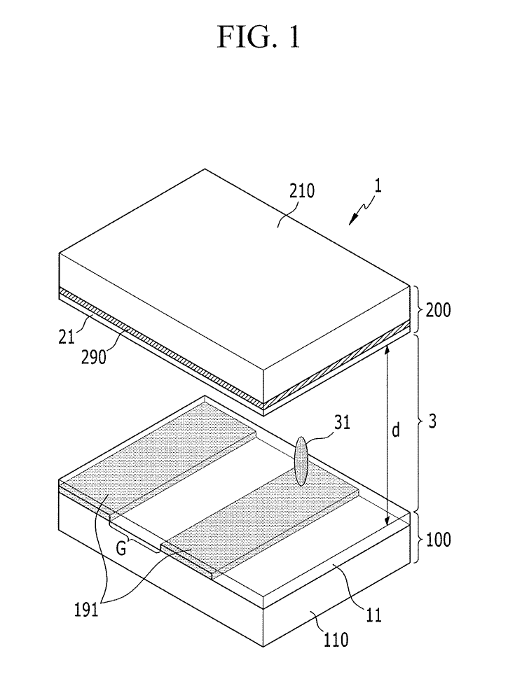

An optical modulation device according to an exemplary embodiment will be described with reference to FIGS. 1 to 3.

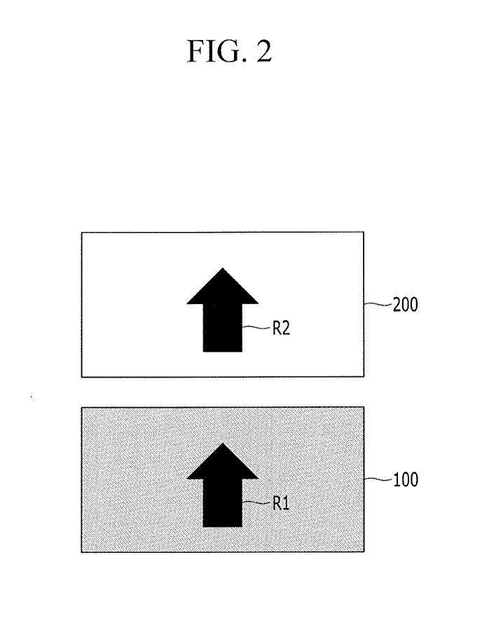

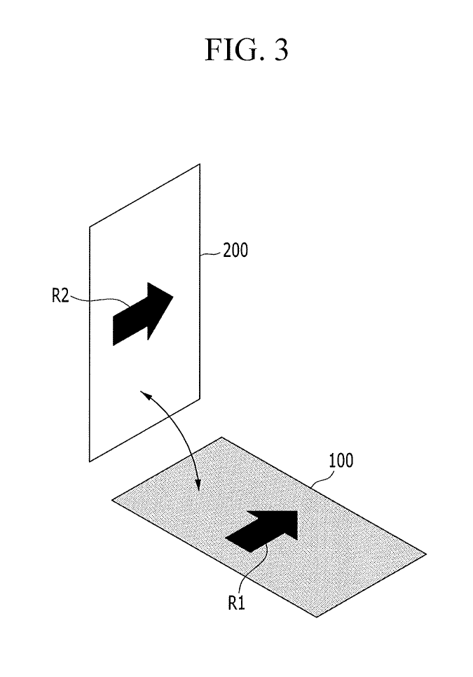

FIG. 1 is a perspective view of an optical modulation device according to an exemplary embodiment, FIG. 2 is a plan view of alignment directions in a first panel and a second panel included in an optical modulation device according to an exemplary embodiment, and FIG. 3 illustrates a process of assembling a first panel and a second panel illustrated in FIG. 2.

Referring to FIG. 1, an optical modulation device 1 according to an exemplary embodiment includes a first panel 100, a second panel 200, and a liquid crystal layer 3 positioned therebetween.

The first panel 100 may include a first substrate 110 made of glass, plastic, etc. The first substrate 110 may be rigid or flexible, and may be flat or at least a part thereof may be curved.

A plurality of lower-panel electrodes 191 are positioned on the first substrate 110. The lower-panel electrodes 191 includes a conductive material and may include a transparent conductive material such as ITO and IZO, metal, etc. The lower-panel electrode 191 may receive a voltage from a voltage applying unit, and different lower-panel electrodes 191 may receive different voltages.

The plurality of lower-panel electrodes 191 may be arranged in a predetermined direction, for example, an x-axis direction, and each lower-panel electrode 191 may extend in a direction substantially perpendicular to the arranged direction, for example, a y-axis direction.

A width of a space G between the adjacent lower-panel electrodes 191 may be adjusted based on a design of the optical modulation device. A ratio of the width of a lower-panel electrode 191 and the space G adjacent to the lower-panel electrode 191 may be approximately N:1, where N is a real number greater than or equal to 1.

The second panel 200 includes a second substrate 210 made of glass, plastic, etc. The second substrate 210 may be rigid or flexible, and may be flat or at least a part thereof may be curved.

An upper-panel electrode 290 is positioned on the second substrate 210. The upper-panel electrode 290 includes a conductive material and may include a transparent conductive material such as ITO and IZO, metal, etc. The upper-panel electrode 290 may receive a voltage from a voltage applying unit. The upper-panel electrode 290 may be formed on the second substrate 210 as a single plate or patterned to have a plurality of separated portions.

The liquid crystal layer 3 includes a plurality of liquid crystal molecules 31. The liquid crystal molecules 31 have negative dielectric anisotropy to align in a transverse direction to a direction of an electric field generated in the liquid crystal layer 3. The liquid crystal molecules 31 are substantially perpendicularly aligned with respect to the second panel 200 and the first panel 100 when no electric field is generated in the liquid crystal layer 3, and may form pre-tilts in a predetermined direction. The liquid crystal molecules 31 may be nematic liquid crystal molecules.

A height d of a cell gap of the liquid crystal layer 3 may substantially satisfy Equation 1 with respect to light of a predetermined wavelength λ. As a result, the optical modulation device 1 according to an exemplary embodiment may substantially function as a half-wavelength plate and be used as a diffraction grid, a lens, etc.

$$\frac{λ}{2} \times 1.3 \geq Δ nd \geq \frac{λ}{2} \qquad ( Equation 1 )$$

In Equation 1, And is a phase retardation value of light passing through the liquid crystal layer 3.

A first alignment director 11 is positioned on an inner surface of the first panel 100 over the lower-panel electrodes 191, and a second alignment director 21 is positioned on an inner surface of the second panel 200 over the upper-panel electrode 290. The first alignment director 11 and the second alignment director 21 may be vertical alignment layers, and be provided with an alignment force by various methods, such as a rubbing process or a photo-alignment process, to align liquid crystal molecules 31 that approach the first panel 100 and the second panel 200 with the pre-tilt directions. When using a rubbing process, the vertical alignment layer may be an organic vertical alignment layer. When using a photo-alignment process, a photo-polymerization material may be formed by irradiating light, such as ultraviolet light, after coating an alignment material that includes a photosensitive polymer material on the inner surfaces of the first panel 100 and the second panel 200.

Referring to FIG. 2, alignment directions R1 and R2 of two alignment directors 11 and 21 positioned on the inner surfaces of the first panel 100 and the second panel 200 are substantially parallel to each other. Further, the alignment directions R1 and R2 of the alignment directors 11 and 21 are constant over the inner surfaces of the first panel 100 and the second panel 200.

If the first panel 100 and the second panel 200 are misaligned, a difference of an azimuthal angle of the first alignment director 11 of the first panel 100 and an azimuthal angle of the second alignment director 21 of the second panel 200 may be approximately ±5, but the differences are not limited thereto.

Referring to FIG. 3, the optical modulation device 1 according to an exemplary embodiment may be formed by aligning and assembling the first panel 100 and the second panel 200 in which are formed alignment directors 11 and 21 aligned substantially parallel.

Unlike those illustrated in FIG. 3, a vertical position of the first panel 100 and the second panel 200 may change.

As such, the alignment directors 11 and 21 formed on the first panel 100 and the second panel 200 of the optical modulation device 1 according to an exemplary embodiment are substantially parallel to each other, and since the alignment directions of the alignment directors 11 and 21 are constant over the inner surfaces of the first and second panels 100 and 200, the process of aligning and manufacturing the optical modulation device may be simplified. Accordingly, it is possible to prevent alignment defects of an optical modulation device or an optical device including the same. Accordingly, an optical modulation device may be easily enlarged.

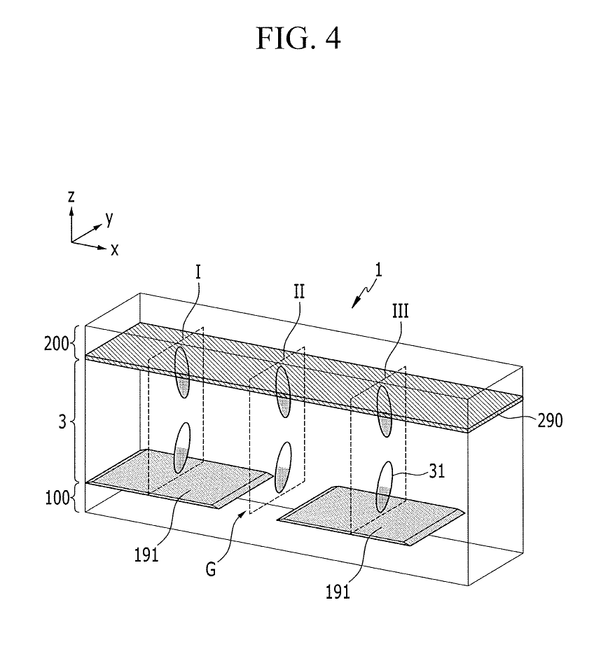

Next, operation of an optical modulation device according to an exemplary embodiment will be described with reference to FIGS. 4 to 7 in addition to FIGS. 1 to 3 described above.

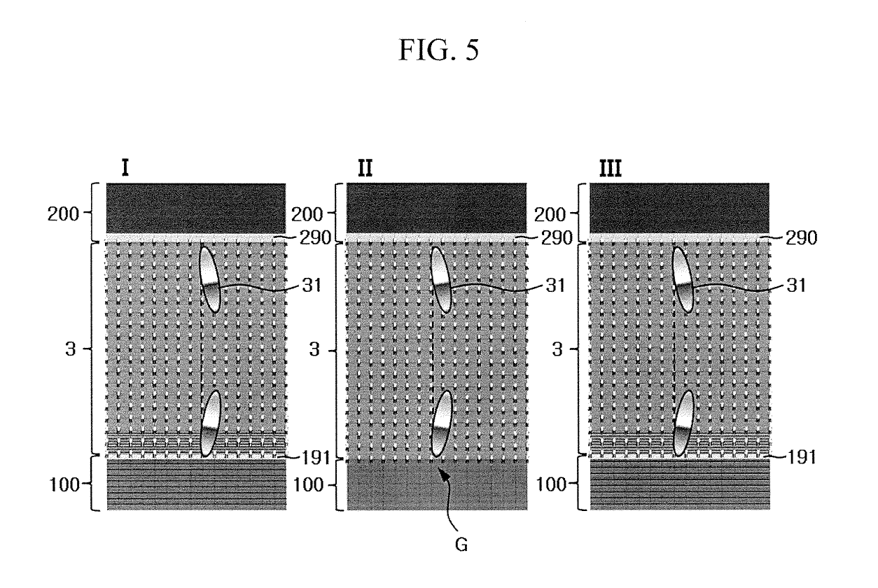

Referring to FIGS. 4 and 5, when no voltage difference is applied between the lower-panel electrodes 191 and the upper-panel electrode 290, and thus no electric field is generated in the liquid crystal layer 3, the liquid crystal molecules 31 are aligned with initial pre-tilts. FIG. 5 includes a cross-sectional view taken along line I in a lower-panel electrode 191 of the optical modulation device 1 illustrated in FIG. 4, a cross-sectional view taken along line II in a space G between two adjacent lower-panel electrodes 191, and a cross-sectional view taken along line III in an adjacent lower-panel electrode 191, and referring to FIG. 5, the alignment of the liquid crystal molecules 31 may be substantially constant.

FIG. 5 appears to show the liquid crystal molecules 31 permeating into the first panel 100 or second panel 200 region, but this is for convenience of illustration. Actually, the liquid crystal molecules 31 do not permeate into the first panel 100 or second panel 200 region, and this is true even in the drawings below.

Since the liquid crystal molecules 31 adjacent to the first panel 100 and the second panel 200 are initially aligned according to parallel alignment directions of the alignment directors 11 and 21, the pre-tilt direction of the liquid crystal molecules 31 adjacent to the first panel 100 and the pre-tilt direction of the liquid crystal molecules 31 adjacent to the second panel 200 are not parallel to each other but opposite to each other. That is, the liquid crystal molecules 31 adjacent to the first panel 100 and the liquid crystal molecules 31 adjacent to the second panel 200 may be tilted in directions that are symmetric with respect to a center line that extends horizontally along the center of the liquid crystal layer 3 in the cross-sectional view. For example, when the liquid crystal molecules 31 adjacent to the first panel 100 are tilted to the right, the liquid crystal molecules 31 adjacent to the second panel 200 may be tilted to the left.

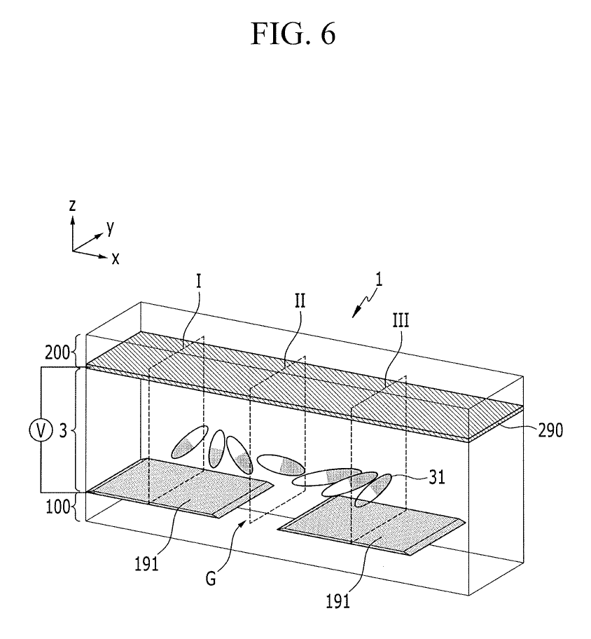

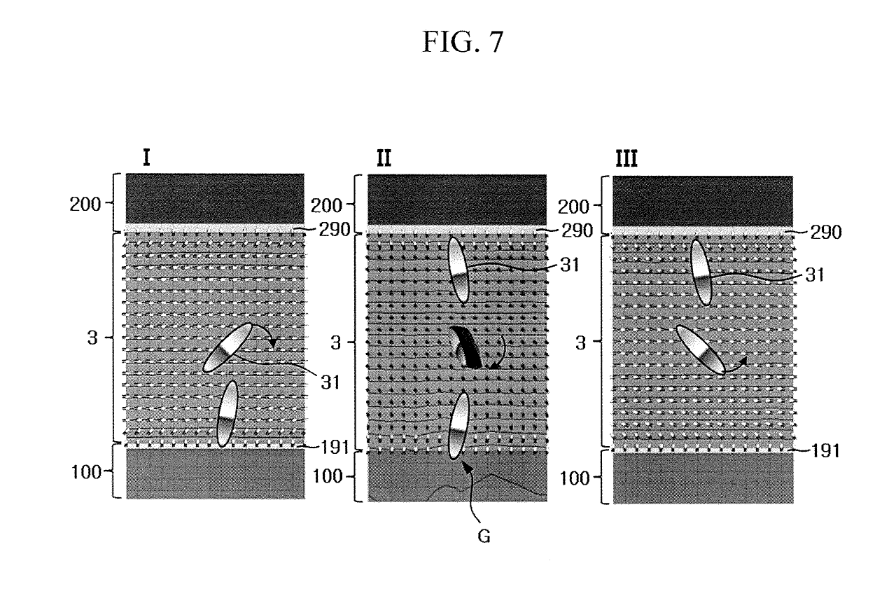

Referring to FIGS. 6 and 7, when a voltage difference greater than a threshold voltage is applied between the lower-panel electrode 191 and the upper-panel electrode 290, an electric field is generated in the liquid crystal layer 3, and the liquid crystal molecules 31, which have negative dielectric anisotropy, tilt in a direction substantially perpendicular to the direction of the electric field. As a result, as illustrated in FIGS. 6 and 7, most liquid crystal molecules 31 tilt substantially parallel to the surface of the first panel 100 or the second panel 200 in an in-plane alignment configuration, in which long axes of the liquid crystal molecules 31 rotate and align in-plane. In-plane alignment means that the long axes of the liquid crystal molecules 31 are aligned parallel to the surface of the first panel 100 or the second panel 200.

In this case, the in-plane rotation angles, that is, azimuthal angles of the liquid crystal molecules 31, may vary according to the voltage applied to the corresponding lower-panel electrode 191 and the upper-panel electrode 290, and as a result, may vary spirally according to a position in the x-axis direction.

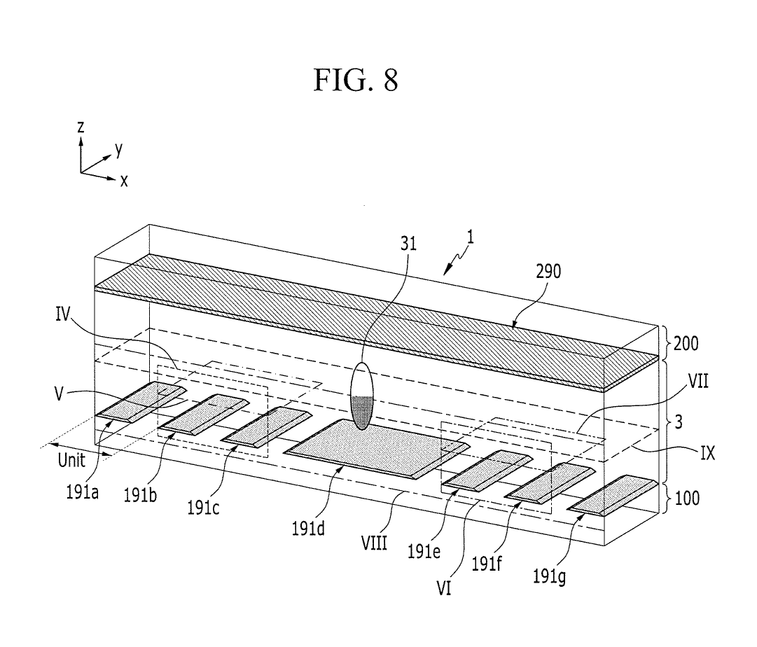

Next, a method of implementing a forward phase slope in the liquid crystal layer using the optical modulation device 1 according to an exemplary embodiment will be described with reference to FIGS. 8 to 12 in addition to the drawings described above.

FIG. 8 illustrates the optical modulation device 1 that includes a liquid crystal according to an exemplary embodiment and may have a same structure as an exemplary embodiment described above. The optical modulation device 1 includes a plurality of units, and each unit may include at least one lower-panel electrode 191. A non-limiting example in which each unit includes one lower-panel electrode 191 is described, and two lower-panel electrodes 191b and 191c positioned in two adjacent units, respectively, will be described. The two lower-panel electrodes 191b and 191c are referred to as a second electrode 191b and a third electrode 191c, respectively.

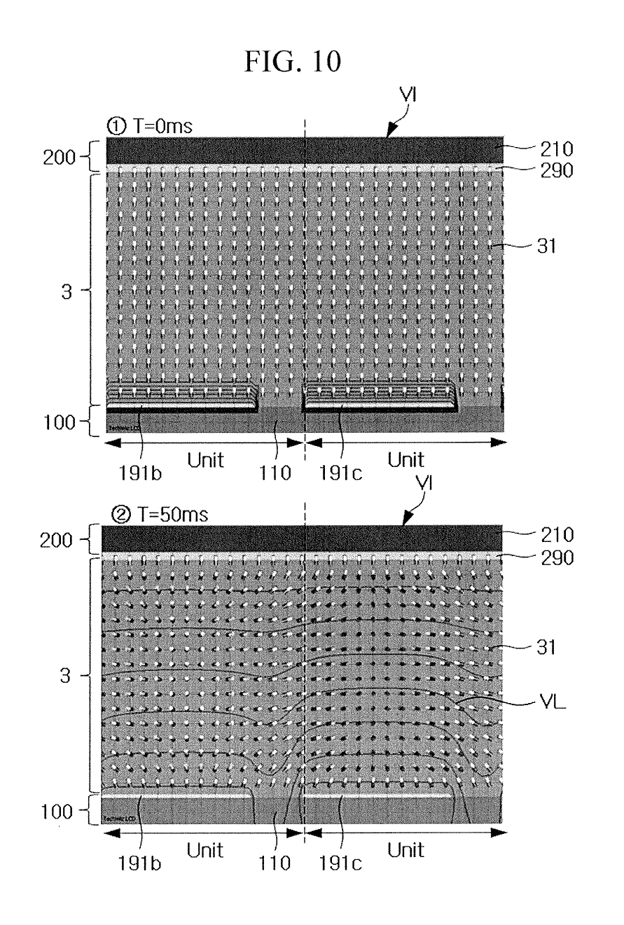

Referring to an upper diagram of FIG. 10, when no voltages are applied to the second and third electrodes 191b and 191c and the upper electrode 290, the liquid crystal molecules 31 align initially in a substantially perpendicular direction to planes of the first panel 100 and the second panel 200, and may form pre-tilts with respect to the first panel 100 and the second panel 200 as described above. In this case, voltages of 0 V may be applied to the second and third electrodes 191b and 191c based on the voltage of the upper-panel electrode 290, and a voltage less than a threshold voltage Vth or less may be applied when an alignment of the liquid crystal molecules 31 starts to change.

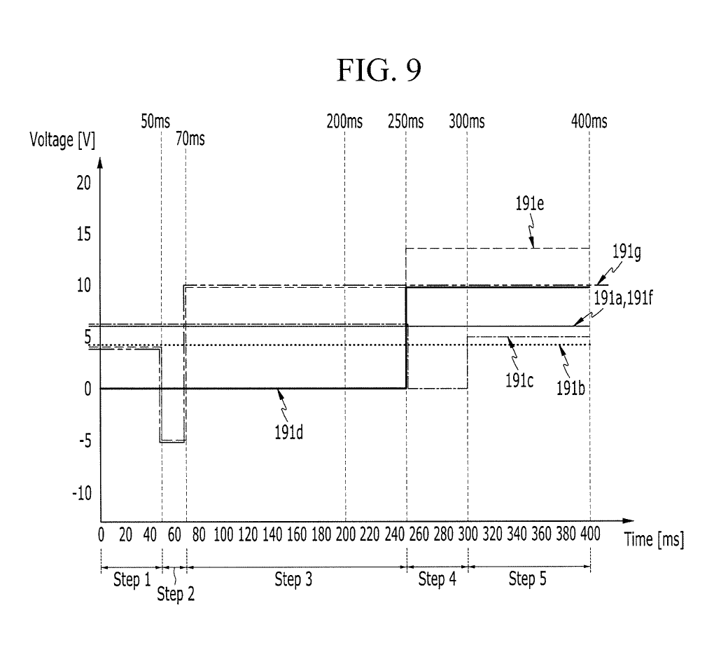

Referring to FIG. 9, first, to implement a forward phase slope in the optical modulation device 1 according to an exemplary embodiment, the lower-panel electrodes 191b and 191c and the upper-panel electrode 290 may receive a driving signal of a first step (step1). In the first step (step1), while a voltage difference forms between the lower-panel electrodes 191b and 191c and the upper-panel electrode 290, a voltage difference forms even between the adjacent second electrode 191b and third electrode 191c. For example, an absolute value of a second voltage applied to the third electrode 191c may be larger than an absolute value of a second voltage applied to the second electrode 191b. Further, a third voltage applied to the upper-panel electrode 290 differs from the second voltages applied to the lower-panel electrodes 191b and 191c. For example, an absolute value of the third voltage applied to the upper-panel electrode 290 may be less than the absolute values of the second voltages applied to the second and third electrodes 191b and 191c. For example, voltages of 4 V, 6 V, and 0 V may be applied to the second electrode 191b, the third electrode 191c, and the upper-panel electrode 290, respectively.

When a unit includes a plurality of lower-panel electrodes 191, a same voltage may be applied to all the plurality of lower-panel electrodes 191 of one unit, and voltages may sequentially change in units of at least one lower-panel electrode 191. In this case, voltages may be applied that gradually increase for groups of at least one adjacent lower-panel electrodes 191 within one unit, and voltages may be applied that gradually decrease for groups of at least one adjacent lower-panel electrodes 191 within an adjacent unit.

The voltages applied to the lower-panel electrodes 191 of all the units may have the same polarities, being positive or negative based on the voltage of the upper-panel electrode 290. Further, the polarity of the voltage applied to the lower-panel electrode 191 may be inverted on a cycle of at least one frame.

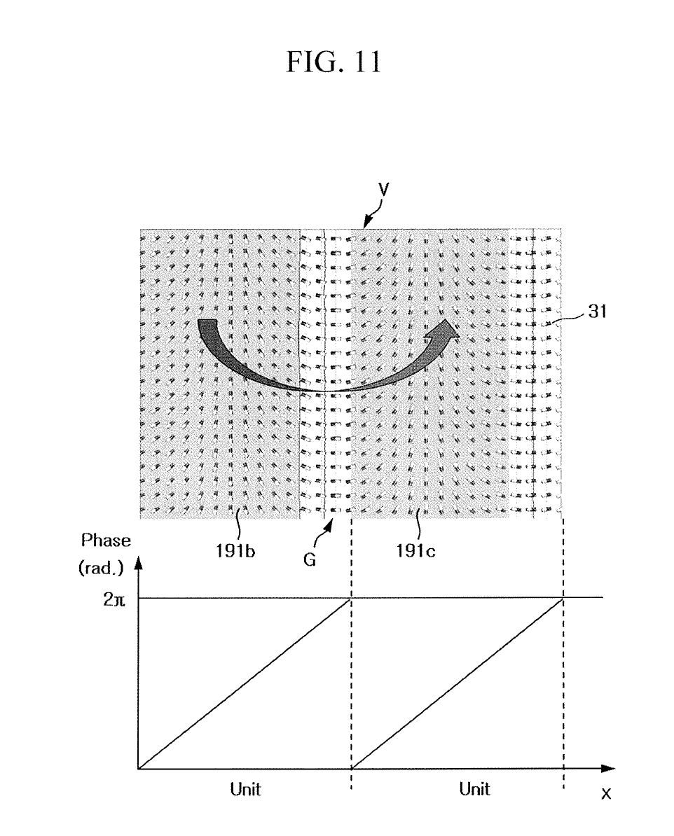

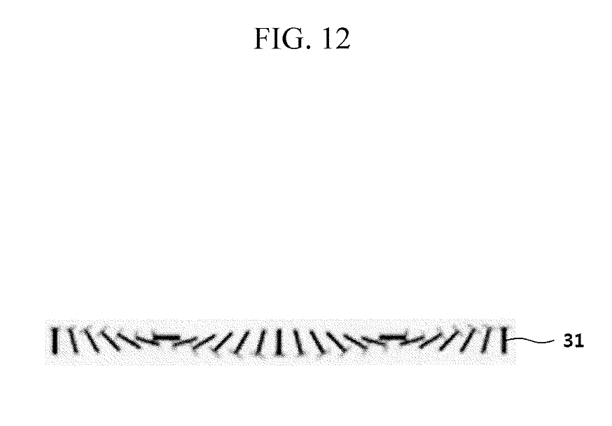

Next, referring to lower diagrams of FIG. 10 and FIG. 11, the liquid crystal molecules 31 realign according to the electric field generated in the liquid crystal layer 3. In detail, most of the liquid crystal molecules 31 tilt substantially parallel to the surface of the first panel 100 or the second panel 200 in an in-plane alignment, and long axes thereof rotate in-plane to form spiral alignment as illustrated in FIGS. 11 and 12, more particularly, a u-shaped alignment. In the liquid crystal layer 3, azimuthal angles of the long axes of the liquid crystal molecules 31 may change from approximately 0° to approximately 180° on a cycle of a pitch of the lower-panel electrodes 191. A portion where the azimuthal angles of the long axes changes from approximately 0° to approximately 180° may form one u-shaped alignment.

It may take a predetermined period of time until the alignment of the liquid crystal molecules 31 stabilizes after the optical modulation device 1 receives the driving signal in the first step (step1). In addition, the optical modulation device 1 forming the forward phase slope may continuously receive the first step (step1) driving signal, unlike those illustrated in FIG. 9.

Referring to FIG. 11, the liquid crystal molecules 31 rotate by about 180° in the x-axis direction, and an aligned region may be defined as one unit. In an exemplary embodiment, one unit may include a space G between the second electrode 191b and the adjacent third electrode 191c.

As described above, when the optical modulation device 1 is implemented as a half-wavelength plate that satisfies Equation 1, a rotation direction of the incident circularly-polarized light is reversed. FIG. 11 illustrates a phase change according to a position in the x-axis direction when the right circularly-polarized light is incident to the optical modulation device 1. The right circularly-polarized light passing through the optical modulation device 1 changes to left circularly-polarized light, and since the phase retardation value of the liquid crystal layer 3 varies in the x-axis direction, the phase of the emitted circularly-polarized light continuously changes.

In general, when an optical axis of the half-wavelength plate rotates by φ in-plane, the phase of the emitted light changes by 2φ, and as a result, the phase of the light emitted from one unit changes from 0 to 2π radian in the x-axis direction when the azimuthal angle of the long axes of the liquid crystal molecules 31 changes by 180°, as illustrated in FIG. 11.

This is referred to as a forward phase slope. The phase change may repeat every unit, and the forward phase slope portion of the lens changing the direction of the light may be implemented using the optical modulation device 1.

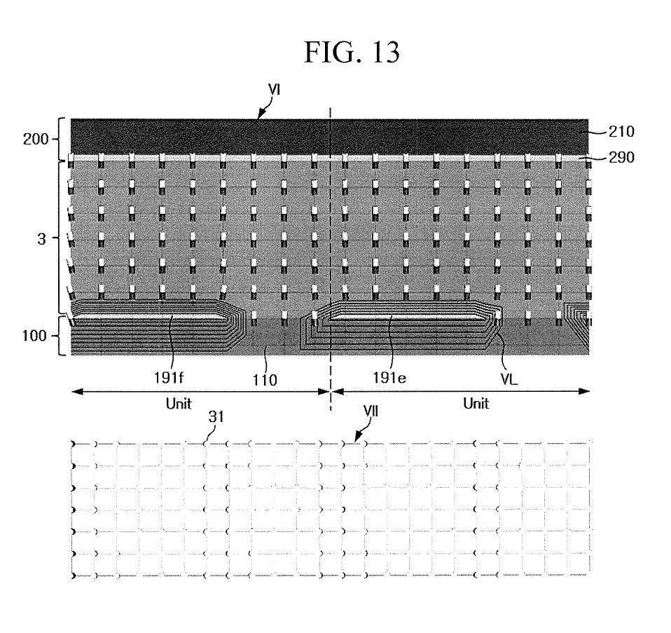

Next, a method of implementing the forward phase slope illustrated in FIG. 11 in the optical modulation device 1 according to an exemplary embodiment will be described with reference to FIGS. 13 to 16 in addition to the drawings described above.

In an exemplary embodiment, two lower-panel electrodes 191e and 191f positioned in two adjacent units, respectively, will be described. The two lower-panel electrodes 191e and 191f are referred to as a fifth electrode 191e and a sixth electrode 191f, respectively.

FIG. 13 is a cross-sectional view taken along line VI of FIG. 8 and a cross-sectional view taken along line VII of alignment of liquid crystal molecules 31 before a voltage difference is applied to the fifth and sixth electrodes 191e and 191f and the upper-panel electrode 290 of the optical modulation device 1.

The liquid crystal molecules 31 are initially aligned to be substantially perpendicular with respect to the planes of the first panel 100 and the second panel 200, and as described above, the liquid crystal molecules 31 may be pre-tilted according to the alignment direction R1 and R2 of the first panel 100 and the second panel 200. Equipotential lines VL are illustrated in the liquid crystal layer 3.

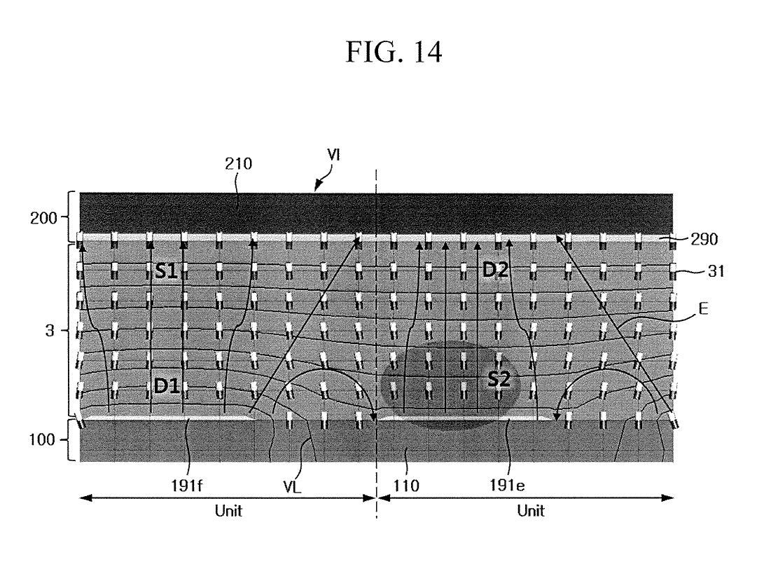

FIG. 14 is a cross-sectional view taken along line VI of FIG. 8 of alignment of liquid crystal molecules 31 immediately after the driving signal is applied in the first step (step1) to the fifth and sixth electrodes 191e and 191f and the upper-panel electrode 290. An electric field E is generated between the first panel 100 and the second panel 200, and as a result, the equipotential lines VL are illustrated. In this case, since the fifth and sixth electrodes 191e and 191f have edge sides, as illustrated in FIG. 14, a fringe field is formed between the edge sides of the fifth and sixth electrodes 191e and 191f and the upper-panel electrode 290.

In the liquid crystal layer 3 of a unit that includes the sixth electrode 191f, immediately after the driving signal is applied in the first step (step1) to the fifth and sixth electrodes 191e and 191f and the upper-panel electrode 290, the intensity of the electric field in a region D1 adjacent to the first panel 100 is greater than the intensity of the electric field in a region S1 adjacent to the second panel 200. In addition, in the liquid crystal layer 3 of a unit including the fifth electrode 191e, the intensity of the electric field in a region S2 adjacent to the first panel 100 is less than the intensity of the electric field in a region D2 adjacent to the second panel 200.

Since there is a difference between the voltages applied to the fifth electrode 191e and the sixth electrode 191f of two adjacent units, as illustrated in FIG. 14, the intensity of the electric field in the region S2 adjacent to the fifth electrode 191e may be less than the intensity of the electric field in the region D1 adjacent to the sixth electrode 191f. To this end, as illustrated in FIG. 9 described above, the voltage applied to the fifth electrode 191e may be less than the voltage applied to the sixth electrode 191f. A voltage different from the voltages applied to the fifth and sixth electrodes 191e and 191f may be applied to the upper-panel electrode 290, and in more detail, a voltage less than the voltage applied to the fifth and sixth electrodes 191e and 191f may be applied.

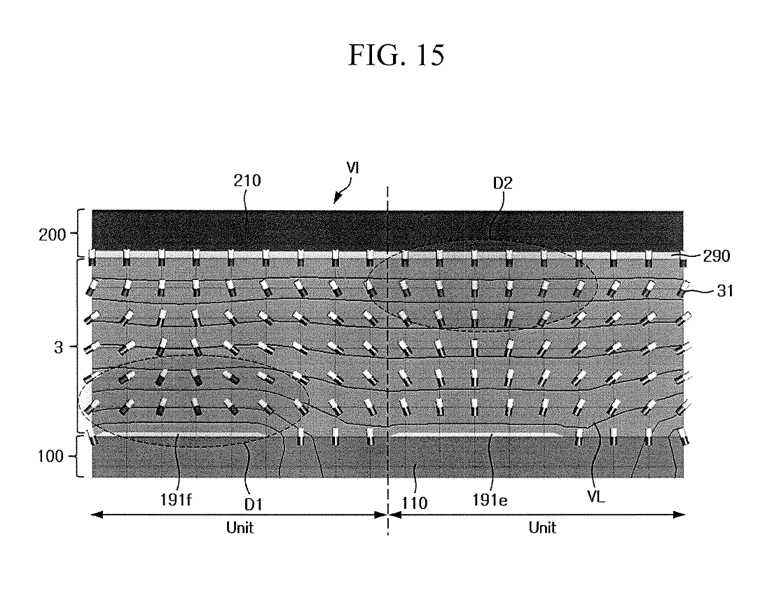

FIG. 15 is a cross-sectional view taken along line VI of FIG. 8 of alignment of the liquid crystal molecules 31 that respond to an electric field E generated in the liquid crystal layer 3 after the driving signal is applied in the first step (step1) in the optical modulation device 1 illustrated in FIG. 8. As described above, since the electric field in the region D1 adjacent to the sixth electrode 191f in the liquid crystal layer 3 is greatest, the tilt direction of the liquid crystal molecules 31 in the region D1 finally determines the in-plane alignment direction of the liquid crystal molecules 31 adjacent to the sixth electrode 191f. Accordingly, in a region adjacent to the sixth electrode 191f, the liquid crystal molecules 31 tilt in the initial pre-tilt direction of the liquid crystal molecules 31 adjacent to the first panel 100 to form an in-plane alignment.

On the contrary, in the liquid crystal layer 3 adjacent to the fifth electrode 191e, since the electric field is greatest in the region D2, which is adjacent to not the fifth electrode 191f but the upper-panel electrode 290 facing the fifth electrode 191e, the tilt direction of the liquid crystal molecules 31 of the region D2 finally determines the in-plane alignment direction of the liquid crystal molecules 31. Accordingly, in the region corresponding to the fifth electrode 191e, the liquid crystal molecules 31 are tilted in the initial pre-tilt direction of the liquid crystal molecules 31 adjacent to the second panel 200 to form the in-plane alignment. Since the initial pre-tilt direction of the liquid crystal molecules 31 adjacent to the first panel 100 and the initial pre-tilt direction of the liquid crystal molecules 31 adjacent to the second panel 200 are opposite to each other, the tilt direction of the liquid crystal molecules 31 corresponding to the fifth electrode 191e is opposite to the tilt direction of the liquid crystal molecules 31 adjacent to the sixth electrode 191f.

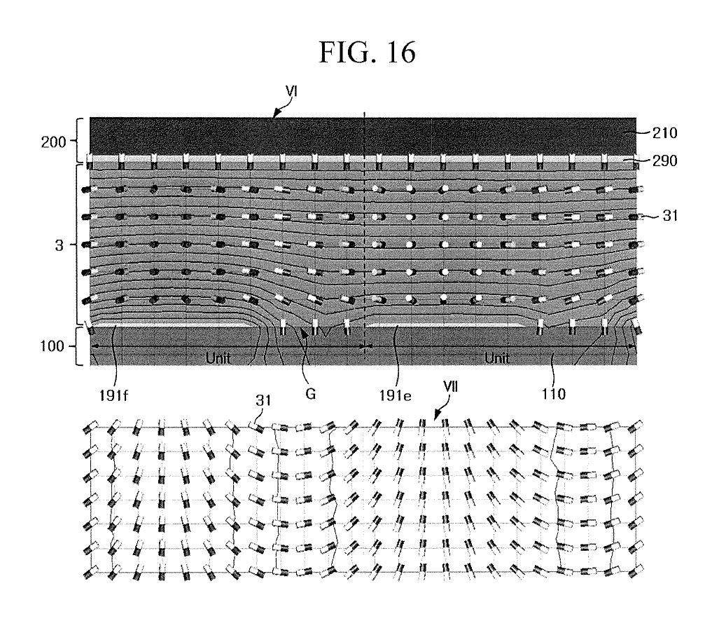

FIG. 16 is a cross-sectional view taken along line VI of FIG. 8 and a cross-sectional view taken along line VII of alignment of the liquid crystal molecules 31 stabilized after the driving signal is applied in the first step (step1) in the optical modulation device 1 illustrated in FIG. 8. The in-plane alignment direction of the liquid crystal molecules 31 corresponding to the fifth electrode 191e is opposite to the in-plane alignment direction of the liquid crystal molecules 31 corresponding to the sixth electrode 191f, and the liquid crystal molecules 31 of the space G between the adjacent fifth and sixth electrodes 191e and 191f continuously rotate in the x-axis direction to form a spiral alignment.

Finally, the liquid crystal layer 3 of the optical modulation device 1 may have a phase retardation effect with respect to the incident light which changes in the x-axis direction.

Referring to FIG. 16, a region in which the alignment of the liquid crystal molecules 31 rotates by 180° in the x-axis direction is defined as one unit, and one unit may include a space G between one lower-panel electrode 191e and an adjacent lower-panel electrode 191f. For example, when right circularly-polarized light is incident to the optical modulation device 1, forming a forward phase slope, right circularly-polarized light changes to left circularly-polarized light, the phase retardation value of the liquid crystal layer 3 varies according to the x-axis direction, and as a result, the phase of the emitted circularly-polarized light continuously changes.

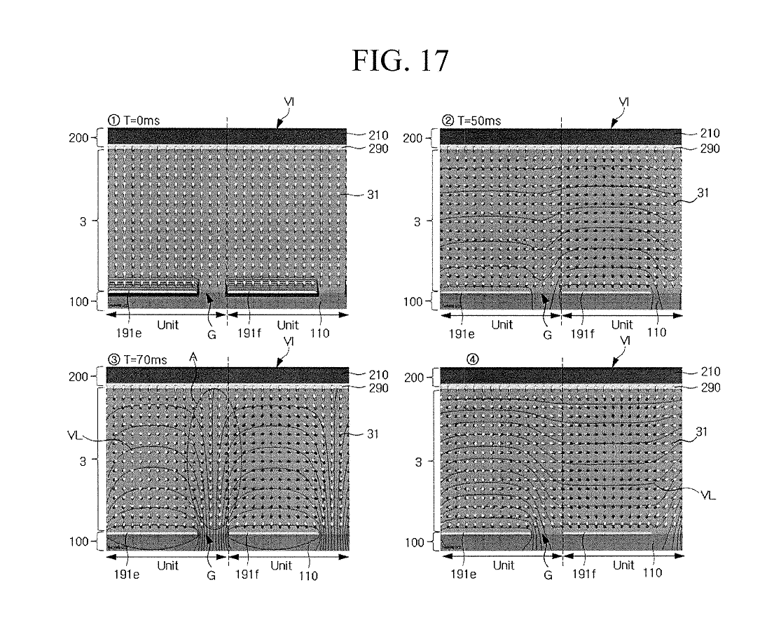

Hereinafter, a method of implementing a backward phase slope using the optical modulation device 1 according to an exemplary embodiment will be described with reference to FIGS. 17 to 19 in addition to the drawings described above, particularly, FIGS. 9 to 11.

Referring to an upper left diagram of FIG. 17, when no voltages are applied to the fifth and sixth electrodes 191e and 191f and the upper-panel electrode 290, the liquid crystal molecules 31 are initially aligned in a substantially perpendicular direction with respect to planes of the first panel 100 and the second panel 200, and may form pre-tilts according to the alignment directions of the first panel 100 and the second panel 200 as described above.

Referring to FIG. 9 described above, after a predetermined time period, for example, 50 ms, elapses after the optical modulation device 1 according to an exemplary embodiment receives the first step (step1) driving signal, the lower-panel electrodes 191e and 191f and the upper-panel electrode 290 may receive a driving signal in a second step (step2).

In the second step (step2), depending on the voltage applied to the upper-panel electrode 290, voltages having opposite polarities may be applied to the adjacent fifth and sixth electrodes 191e and 191f. For example, based on the voltage of the upper-panel electrode 290, a voltage of −6 V may be applied to the fifth electrode 191e and a voltage of 6 V may be applied to the sixth electrode 191f, or vice versa.

Then, as illustrated in a lower left diagram of FIG. 17 by the equipotential lines, the liquid crystal molecules 31 in a region A corresponding to the space G between the fifth and sixth electrodes 191e and 191f align in a substantially perpendicular direction with respect to the panels 100 and 200, and the in-plane spiral alignment is broken.

A duration of the second step (step2) may be, for example, 20 ms, but the duration is not limited thereto.

If the unit includes a plurality of lower-panel electrodes 191, the same voltage may be applied to all the plurality of lower-panel electrodes 191 of one unit and voltages may by applied that sequentially change for each unit. The voltages applied to the lower-panel electrodes 191 of adjacent units may have opposite polarities with to the voltage of the upper-panel electrode 290. Further, the polarity of the voltages applied to the lower-panel electrode 191 may be inverted on a cycle of at least one frame.

Next, after a predetermined time period, for example, 20 ms, elapses after the optical modulation device 1 according to an exemplary embodiment receives the second step (step2) driving signal, the lower-panel electrodes 191e and 191f and the upper-panel electrode 290 may receive a driving signal in a third step (step3), and the received driving signal may be maintained for the remaining period of the corresponding frame.

In the third step (step3), voltage levels applied to the lower-panel electrodes 191e and 191f and the upper-panel electrode 290 are similar to those in the first step (step1), but relative magnitudes of the voltages applied to the fifth electrode 191e and the sixth electrode 191f may be reversed. That is, if in the first step (step1) the voltage applied to the fifth electrode 191e is less than the voltage applied to the sixth electrode 191f, then in the third step (step3) the voltage applied to the fifth electrode 191e may be greater than the voltage applied to the sixth electrode 191f. For example, in the third step (step3), voltages of 10V, 6 V, and 0 V may be applied to the fifth electrode 191e, the sixth electrode 191f, and the upper-panel electrode 290, respectively.

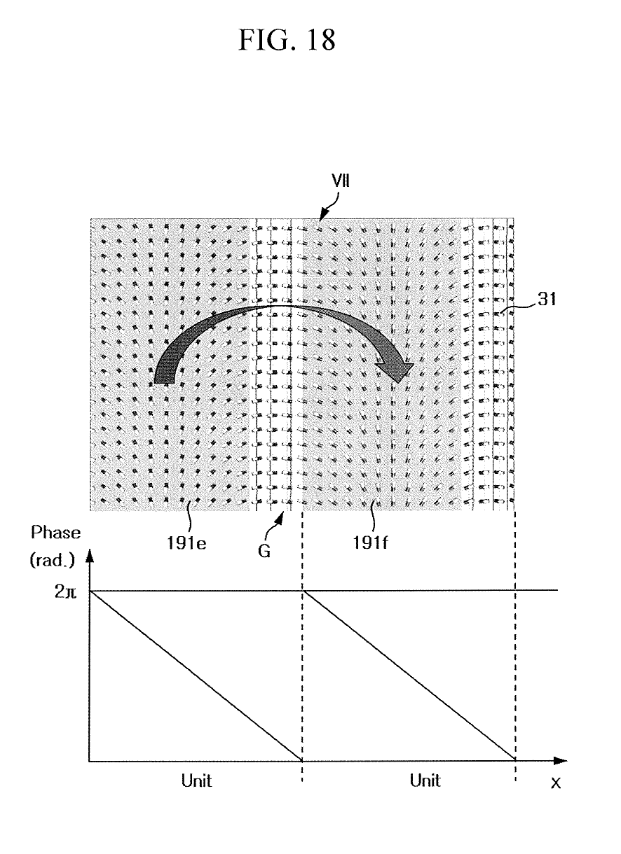

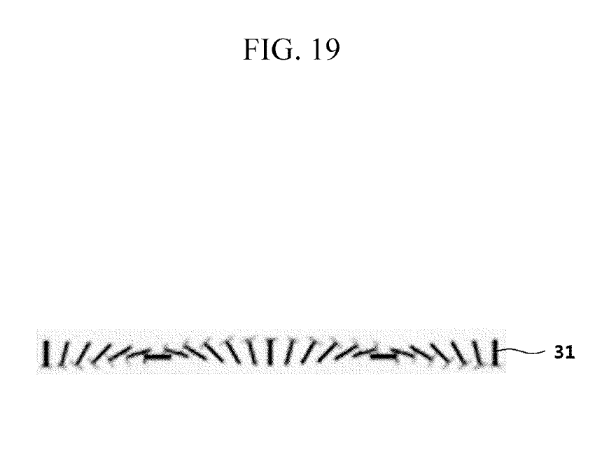

Next, as in a lower right diagram of FIG. 17, the liquid crystal molecules 31 realign according to the electric field generated in the liquid crystal layer 3. In detail, most of the liquid crystal molecules 31 tilt substantially parallel to the surface of the first panel 100 or the second panel 200 to form an in-plane alignment, and long axes thereof rotate in-plane to form a spiral alignment as illustrated in FIGS. 18 and 19, and more particularly, form an n-shaped alignment. In the liquid crystal molecules 31, azimuthal angles of the long axes of the liquid crystal molecules 31 may change from approximately 180° to approximately 0° over a pitch cycle of the lower-panel electrode 191. A portion where the azimuthal angles of the long axes of the liquid crystal molecules 31 changes from approximately 180° to approximately 0° may form one n-shaped alignment.

It may take a predetermined time period until an alignment of the liquid crystal molecules 31 stabilizes after the optical modulation device 1 receives the third step (step3) driving signal. In addition, the optical modulation device 1 forming a backward phase slope may continuously receive the third step (step3) driving signal.

As described above, when the optical modulation device 1 is implemented substantially as a half-wavelength plate that satisfies Equation 1, a rotation direction of the incident circularly-polarized light is reversed. FIG. 18 illustrates a phase change according to a position in the x-axis direction when right circularly-polarized light is incident to the optical modulation device 1. Right circularly-polarized light passing through the optical modulation device 1 changes to left circularly-polarized light, and since the phase retardation value of the liquid crystal layer 3 varies in the x-axis direction, the phase of the emitted circularly-polarized light continuously changes.

In general, when an optical axis of a half-wavelength plate rotates by φ in-plane, the phase of the emitted light changes by 2φ, and as a result, as illustrated in FIG. 18, the phase of light emitted from one unit in which the azimuthal angle of the long axes of the liquid crystal molecules 31 changes to 180° changes from 2π (radian) to 0 in the x-axis direction. This is referred to as a backward phase slope. The phase change may repeat for every unit, and the backward phase slope portion of a lens for changing the direction of light may be implemented using the optical modulation device 1.

Since a principle of a method of implementing a backward phase slope is the same as that of a method of implementing a forward phase slope, a further detailed description thereof is omitted.

As such, according to an exemplary embodiment, the in-plane rotation angle of the liquid crystal molecules 31 is easily controlled by applying a driving signal to modulate an optical phase and form various diffraction angles of light.

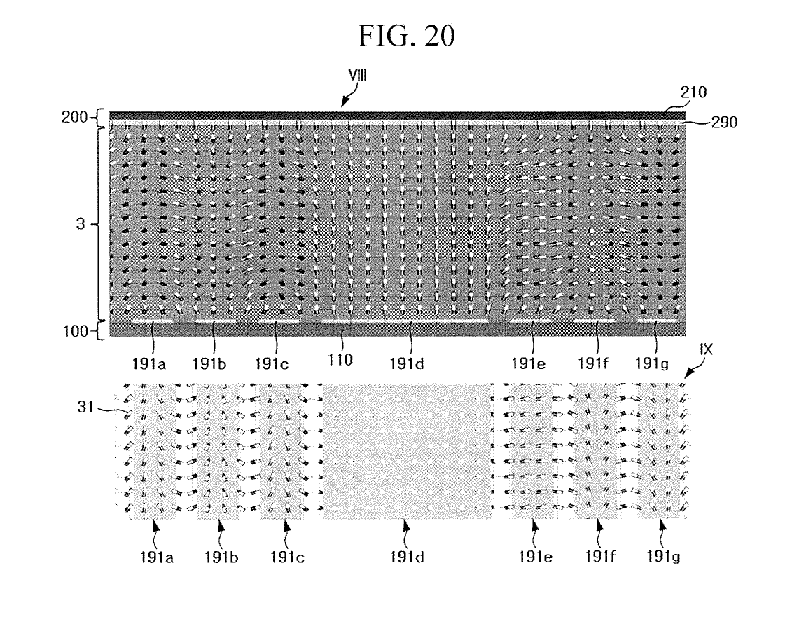

Next, a method of implementing a lens center where a forward phase slope and a backward phase slope connect will be described with reference to FIGS. 20 to 22.

In an exemplary embodiment, three lower-panel electrodes 191c, 191d, and 191e positioned in three adjacent units, respectively, will be described. The three lower-panel electrodes 191c, 191d, and 191e may be referred to as a third electrode 191c, a fourth electrode 191d, and a fifth electrode 191e, respectively.

FIG. 20 is a cross-sectional view taken along line VIII of FIG. 8 and a cross-sectional view taken along line IX of alignment of liquid crystal molecules that have stabilized after the third step (step3) driving signals have been applied.

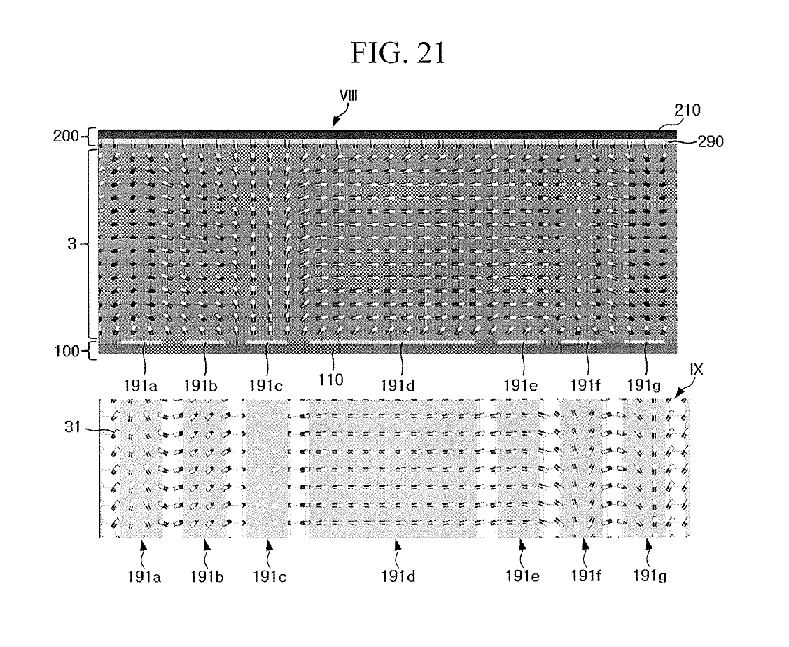

FIG. 21 is a cross-sectional view taken along line VIII of FIG. 8 and a cross-sectional view taken along line IX of alignment of liquid crystal molecules that have stabilized after fourth step (step4) driving signals have been applied.

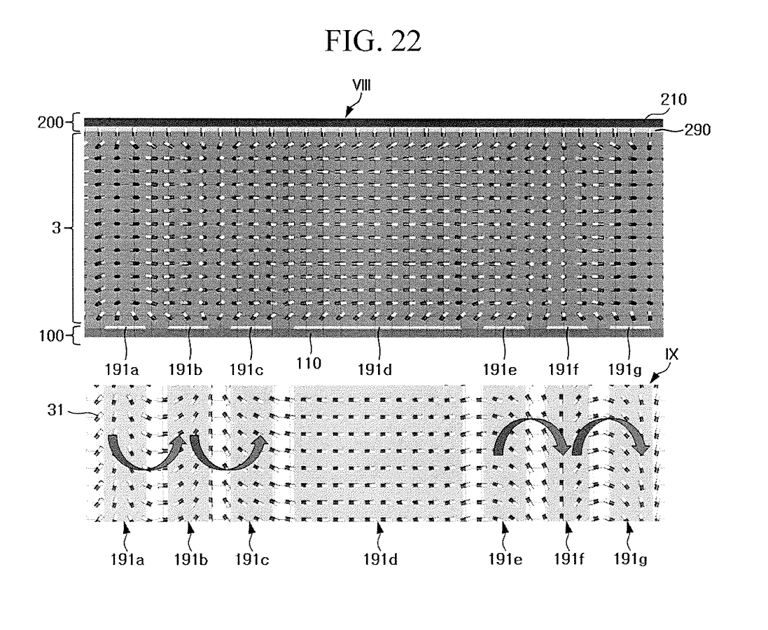

FIG. 22 is a cross-sectional view taken along line VIII of FIG. 8 and a cross-sectional view taken along line IX of alignment of liquid crystal molecules that have stabilized after fifth step (step5) driving signals have been applied.

As illustrated in FIG. 20, from the first step (step1) to the third step (step3), a greater voltage is applied to the first electrode 191a and the third electrode 191c than to the second electrode 191b, and as a result, the liquid crystal molecules 31 at a left side of the fourth electrode 191d realign according to the electric field generated in the liquid crystal layer 3.

In detail, most of the liquid crystal molecules 31 at the left side of the fourth electrode 191d tilt substantially parallel to the surface of the first panel 100 or the second panel 200 to form an in-plane alignment, and long axes thereof rotate in-plane to form spiral alignment as illustrated in FIG. 11 and in particular, form a U-shaped alignment.

In detail: in the first step (step1), a voltage is applied to the fifth and seventh electrodes 191e and 191g is greater than that applied to the sixth electrode 191f; in the second step (step2), voltages having polarities opposite to the voltage applied to the upper electrode 290 are applied to the fifth and seventh electrodes 191e and 191g, and the sixth electrode 191f; and the third step (step3), voltage levels applied to the lower electrodes 191e, 191f, and 191g and the upper electrode 290 are similar to those applied in the first step (step1), except that relative magnitudes of the voltages applied to the fifth and seventh electrodes 191e and 191g and the sixth electrode 191f may change to be opposite to each other.

Then, the liquid crystal molecules 31 at a right side of the fourth electrode 191d realign according to the electric field generated in the liquid crystal layer 3. In detail, most of the liquid crystal molecules 31 at the right side of the fourth electrode 191d tilt substantially parallel to the surface of the first panel 100 or the second panel 200 to form an in-plane alignment, and the long axes thereof rotate in-plane to form a spiral alignment as illustrated in FIGS. 18 and 19 and in particular, form an n-shaped alignment.

In addition, in the third step (step3), a voltage applied the fourth electrode 191d is less than that applied to the third and fifth electrodes 191c and 191e. For example, based on the voltage of the upper electrode 290, a voltage of +6 V may be applied to the third electrode 191c and a voltage of 10 V may be applied to the fifth electrode 191e. In addition a voltage of 0V may be applied to the fourth electrode 191d. Then, the liquid crystal molecules 31 in an area corresponding to the fourth electrode 191d align substantially perpendicularly to the second panel 200 and the first panel 100.

Referring to FIG. 9 described above, after a predetermined time period, for example, 180 ms, has elapsed after the optical modulation device 1 according to the exemplary embodiment receives a third step (step3) driving signal, the lower electrodes 191c, 191d, and 191e and the upper electrode 290 may receive a fourth step (step4) driving signal.

In the fourth step (step4), relative magnitudes of the voltages applied to the third and fourth electrodes 191c and 191d may change to be opposite to each other, while the relative magnitudes of the voltages applied to the fourth and fifth electrodes 191d and 191e may be maintained.

That is, in the third step (step3), the voltage applied to the fourth electrode 191d may be less than the voltage applied to the third voltage 191c, and in the fourth step (step4), the voltage applied to the fourth electrode 191d may be greater than the voltage applied to the third electrode 191c.

Further, in the third step (step3) and the fourth step (step4), the voltage applied to the fifth electrode 191e may be greater than the voltage applied to the fourth electrode 191d. For example, in the fourth step (step4), voltages of 13 V, 10 V, 0 V, and 0 V may be respectively applied to the fifth electrode 191e, the fourth electrode 191d, the third electrode 191c, and the upper electrode 290.

Then, as illustrated in FIG. 21, the liquid crystal molecules 31 realign according to the electric field generated in the liquid crystal layer 3. In detail, most of the liquid crystal molecules 31 in the area corresponding to the fourth electrode 191d tilt substantially parallel to the surface of the first panel 100 or the second panel 200 to form an in-plane alignment, and the long axes thereof rotate in-plane to align parallel to the x axis. In addition, the liquid crystal molecules 31 in an area corresponding to the third electrode 191c align substantially perpendicular with respect to the second panel 200 and the first panel 100.

Next, after a predetermined time period, for example, 50 ms, has elapsed after the optical modulation device 1 according to the exemplary embodiment receives the fourth step (step4) driving signal, the lower electrodes 191c, 191d, and 191e and the upper electrode 290 may receive a fifth step (step5) driving signal, and the current voltage may be maintained during the residual interval of the corresponding frame.

In the fifth step (step5), a voltage applied to the third electrode 191c may be relatively greater than the voltage applied to the second electrode 191b and be relatively less than the voltage applied to the fourth electrode 191d. For example, based on the voltage of the upper electrode 290, if 4 V is applied to the second electrode 191b and 10 V is applied the fourth electrode 191d a voltage of 5 V may be applied to the third electrode 191c.

Then, as illustrated in FIG. 22, the liquid crystal molecules 31 in the area corresponding to the third electrode 191c realign according to the electric field generated in the liquid crystal layer 3. 5 V is applied to the third electrode 191c, and as a result, the electric field may be directed toward the second electrode 191b, which is applied with 4 V, from the third electrode 191c. In detail, most of the liquid crystal molecules 31 in the area corresponding to the third electrode 191c tilt substantially parallel to the surface of the first panel 100 or the second panel 200 to form an in-plane alignment, and the long axes thereof rotate in-plane to form a spiral alignment and in particular, form a u-shaped alignment.

As such, according to an exemplary embodiment, the in-plane rotation angles of the liquid crystal molecules 31 are easily controlled by a method of applying the driving signal to modulate an optical phase and form various diffraction angles of light.

Further according to an exemplary embodiment, it is possible to smoothly connect the left forward phase slope and the right backward phase slope based on lens center having a relatively constant phase.

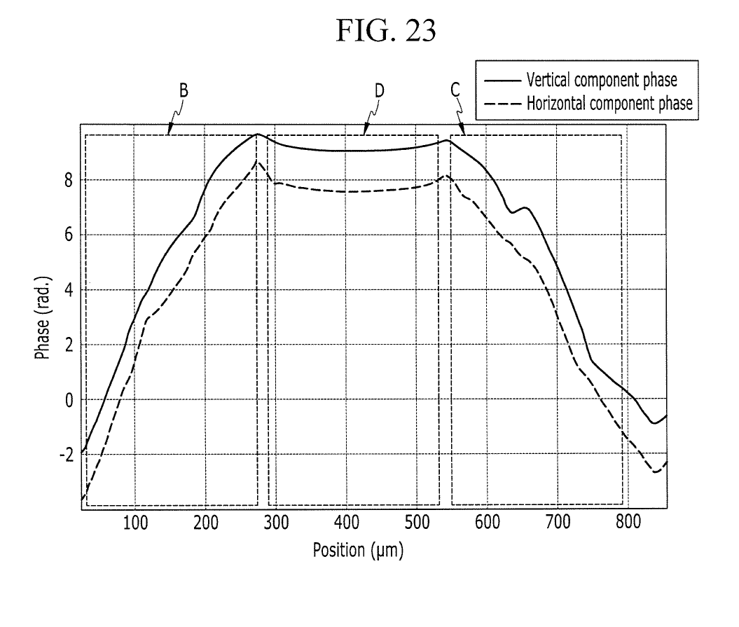

FIG. 23 is a graph of a simulation of a phase change according to a position of light passing through an optical modulation device according to an exemplary embodiment. Referring to FIG. 23, when the first step (step1) driving signal described above is applied to the optical modulation device 1, it can be seen that a forward phase slope may be implemented as a function of position, as shown in part B.

When the first step (step1) to third step (step3) driving signals described above are sequentially applied to the optical modulation device 1, it can be seen that a backward phase slope may be implemented as a function of position, as shown in part C.

When the first step (step1) to fifth step (step5) driving signals described above are sequentially applied to the optical modulation device 1, it can be seen that phase slope may be implemented that is a substantially constant function of position, as shown in part D.

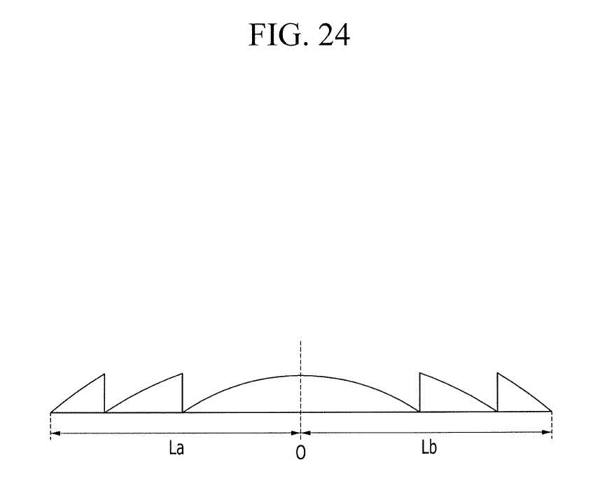

FIG. 24 illustrates a phase change as a function of a lens position which may be implemented using an optical modulation device according to an exemplary embodiment. The optical modulation device 1 may implement both a forward phase slope and a backward phase slope to form the lens by varying the method of applying a driving signal as a function of position as described above.

FIG. 24 illustrates a phase change as a function of position of a Fresnel lens as an example of a lens which may be implemented by the optical modulation device 1. A Fresnel lens has optical characteristics of a Fresnel zone plate, and since a phase distribution repeats periodically, effective phase retardation may be the same as or similar to that of a solid convex lens or a green lens.

As illustrated in FIG. 24, based on the center O of a Fresnel lens, a left portion La includes a plurality of forward phase slope areas of which x-axis direction widths may differ, and a right portion Lb includes a plurality of backward phase slope areas of which x-axis direction widths may differ. Therefore, only the first step (step1) driving signal of the described above is applied to the portion of the optical modulation device 1 corresponding to the left portion La of the Fresnel lens to form the forward phase slope and first step (step1), second step (step2), and third step (step3) driving signals are sequentially applied to a portion of the optical modulation device 1 corresponding to the right portion Lb of the Fresnel lens to form the backward phase slope. Further, first step (step1) to fifth step (step5) driving signals are sequentially applied to a portion of the optical modulation device 1 corresponding to the center of the Fresnel lens to form the constant phase slope.

The widths of the plurality of forward phase slopes included in the left portion Lb of the Fresnel lens may differ according to position, and to this end, the widths of the lower-panel electrode 191 and/or the number of lower-panel electrodes 191 included in one unit of the optical modulation device 1 corresponding to each forward phase slope may be properly controlled. Similarly, the widths of the plurality of backward phase slopes included in the right portion Lb of the Fresnel lens may differ according to position, and to this end, the width of the lower-panel electrode 191 and/or the number of lower-panel electrodes 191 included in one unit of the optical modulation device 1 corresponding to each backward phase slope may be properly controlled.

When the voltages applied to the lower-panel electrode 191 and the upper-panel electrode 290 are controlled, a phase curvature of the Fresnel lens may also be changed.

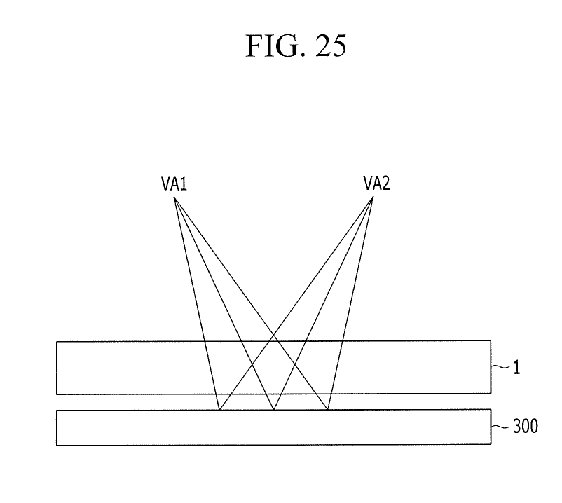

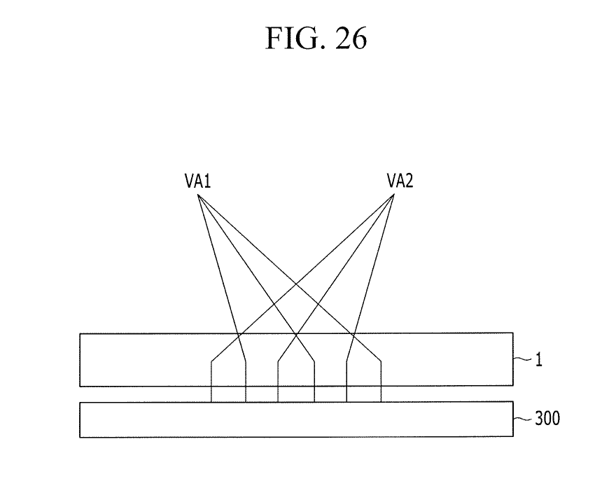

FIGS. 25 and 26 illustrate a schematic structure of a 3D image display device as an example of an optical device using an optical modulation device according to an exemplary embodiment and a method of displaying a 2D image and a 3D image, respectively.

An optical device according to an exemplary embodiment that can function as a 3D image display device may include a display panel 300 and an optical modulation device 1 positioned in front of a front surface of the display panel 300 on which an image is displayed. The display panel 300 may include a plurality of pixels displaying an image, and the plurality of pixels may be arranged in a matrix form.

In 2D mode, the display panel 300 may display a 2D image for each frame displayed by the display panel 300, as illustrated in FIG. 25, and in 3D mode, may divide and display images corresponding to various viewpoints, such as a right-eye image VA2 and a left-eye image VA1, by a spatial division method, as illustrated in FIG. 26. In 3D mode, some of the plurality of pixels may display an image corresponding to one viewpoint, and the others may display images corresponding to other viewpoints. The number of viewpoints may be two or more.

The optical modulation device 1 can repetitively implement a Fresnel lens that includes a plurality of forward phase slope portions and a plurality of backward phase slope portions to divide images displayed on the display panel 300 for each viewpoint.

The optical modulation device 1 may be switched on/off. When the optical modulation device 1 is switched on, the 3D image display device operates in 3D mode, and as illustrated in FIG. 26, the image displayed on the display panel 300 is refracted to form a plurality of Fresnel lenses which display the image at corresponding viewpoints. On the other hand, when the optical modulation device 1 is switched off, as illustrated in FIG. 25, the image displayed on the display panel 300 is not refracted but transmitted to be viewed as the 2D image.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A driving method of an optical modulation device, wherein
the optical modulation device including a first panel that includes a plurality of lower-panel electrodes, a second panel facing the first panel and that includes at least one upper-panel electrode, and a liquid crystal layer positioned between the first panel and the second panel, the method comprising:
applying a voltage to the upper-panel electrode;
forming a forward phase slope by applying a first driving signal to at least one lower-panel electrode corresponding to a first region;
forming a backward phase slope by applying a second driving signal different from the first driving signal to at least one lower-panel electrode corresponding to a second region; and
forming a flat phase slope by applying a third driving signal different from the first driving signal and the second driving signal to at least one lower-panel electrode corresponding to a third region between the first region and the second region.

2. The driving method of claim 1, wherein
when the first driving signal is applied to at least one lower-panel electrode corresponding to the first region,
an absolute value of a first voltage applied to a lower-panel electrode in a first unit in the first region is less than an absolute value of a second voltage applied to a lower-panel electrode in a second unit adjacent to the first unit, and a polarity of the first voltage applied to the lower-panel electrode in the first unit is the same as the polarity of the second voltage applied to the lower-panel electrode in the second unit.

3. The driving method of claim 1, wherein:
forming the backward phase slope in the second region includes
applying the first driving signal to the at least one lower-panel electrode corresponding to the second region;
applying the second driving signal after a first time period elapses to the at least one lower-panel electrode corresponding to the second region; and
applying a fourth driving signal after a second time period elapses.

4. The driving method of claim 3, wherein:
when the second driving signal is applied to the at least one lower-panel electrode corresponding to the second region, a third voltage applied to the lower-panel electrode in a first unit included in the second region has a polarity opposite to a polarity of a fourth voltage applied to the lower-panel electrode in a second unit adjacent to the first unit.

5. The driving method of claim 4, wherein:
when the fourth driving signal is applied to the at least one lower-panel electrode corresponding to the second region, an absolute value of a fifth voltage applied to the lower-panel electrode in the first unit is greater than an absolute value of a sixth voltage applied to the lower-panel electrode in the second unit.

6. The driving method of claim 1, wherein:
the forming of the flat phase slope in the third region includes
applying the first driving signal to at least one lower-panel electrode corresponding to the third region;
applying the second driving signal after a first time period elapses to at least one lower-panel electrode corresponding to the third region;
applying a fourth driving signal after a second time period elapses to at least one lower-panel electrode corresponding to the third region;
applying the third driving signal after a third time period elapses to at least one lower-panel electrode corresponding to the third region; and
applying a fifth driving signal after a fourth time period elapses.

7. The driving method of claim 6, wherein:
the third region includes a first unit, a second unit adjacent to the first unit, and a third unit adjacent to the second unit, and
when the fourth driving signal is applied to at least one lower-panel electrode corresponding to the third region,
a first voltage applied to the lower-panel electrode in the first unit is greater than a second voltage applied to the lower-panel electrode in the second unit and a third voltage applied to the lower-panel electrode in the third unit.

8. The driving method of claim 7, wherein:
when the fourth driving signal is applied to the at least one lower-panel electrode corresponding to the third region,
polarities of the first voltage, the second voltage, and the third voltage applied to the lower panel electrodes are the same as each other.

9. The driving method of claim 7, wherein:
when the third driving signal is applied to the at least one lower-panel electrode corresponding to the third region,
an absolute value of a fourth voltage applied to the lower-panel electrode in the third unit is less than an absolute value of a fifth voltage applied to the lower-panel electrode in the first unit and an absolute value of a sixth voltage applied to the lower-panel electrode in the second unit,
the absolute value of the sixth voltage is less than the absolute value of the fifth voltage, and
the absolute value of the fifth voltage is greater than the absolute value of the first voltage.

10. The driving method of claim 9, wherein:
when the fifth driving signal is applied to the at least one lower-panel electrode corresponding to the third region,
an absolute value of a seventh voltage applied to the lower-panel electrode in the third unit is less than the absolute value of the sixth voltage, and
an absolute value of an eighth voltage applied to the lower-panel electrode adjacent to the lower-panel electrode included in the third unit of the first region is less than the absolute value of the seventh voltage.

11. An optical modulation device, comprising:
a first panel that includes a plurality of lower-panel electrodes and a first alignment director;
a second panel facing the first panel and that includes at least one upper-panel electrode and a second alignment director; and
a liquid crystal layer positioned between the first panel and the second panel and that includes a plurality of liquid crystal molecules,
wherein an alignment direction of the first alignment director and an alignment direction of the second alignment director are substantially parallel to each other, and,
wherein when a voltage is applied to the upper-panel electrode,
a forward phase slope is formed by applying a first driving signal to at least one lower-panel electrode corresponding to a first region,
a backward phase slope is formed by applying a second driving signal different from the first driving signal to at least one lower-panel electrode corresponding to a second region, and
a flat phase slope is formed by applying a third driving signal different from the first driving signal and the second driving signal to at least one lower-panel electrode corresponding to a third region between the first region and the second region.

12. The optical modulation device of claim 11, wherein:
an absolute value of a first voltage applied to a lower-panel electrode in a first unit in the first region is less than an absolute value of a second voltage applied to a lower-panel electrode in a second unit adjacent to the first unit.

13. The optical modulation device of claim 11, wherein:
the second region receives a second driving signal after a first time period elapses after receiving the first driving signal and receives a fourth driving signal after a second time period elapses after receiving the second driving signal to form the backward phase slope.

14. The optical modulation device of claim 11, wherein:
the second region receives the second driving signal after a first time period elapses after receiving the first driving signal and receives a fourth driving signal after a second time period elapses after receiving the second driving signal, and
the third region receives the third driving signal after a third time period elapses after receiving the fourth driving signal and receives a fifth driving signal after a fourth time period elapses after receiving the third driving signal to form the flat phase slope.

15. The optical modulation device of claim 14, wherein:
the third region includes a first unit, a second unit adjacent to the first unit, and a third unit adjacent to the second unit, and
when the third region receives the third driving signal, an absolute value of a fourth voltage applied to the lower-panel electrode in the third unit is less than an absolute value of a fifth voltage applied to the lower-panel electrode in the first unit and an absolute value of a sixth voltage applied to the lower-panel electrode in the second unit.

16. The optical modulation device of claim 15, wherein:
when the third region receives the fifth driving signal, an absolute value of a seventh voltage applied to the lower-panel electrode in the third unit is less than the absolute value of the sixth voltage.

17. A driving method of an optical modulation device, wherein
the optical modulation device includes a first panel that includes a plurality of lower-panel electrodes, a second panel facing the first panel and that includes at least one upper-panel electrode, and a liquid crystal layer positioned between the first panel and the second panel, the method comprising:
applying a voltage to the upper-panel electrode; and
forming a flat phase slope in to at least one lower-panel electrode corresponding to a third region between a first region and a second region by applying a first driving signal to at least one lower-panel electrode corresponding to the first region, applying a second driving signal after a first time period elapses to at least one lower-panel electrode corresponding to the second region, applying a fourth driving signal after a second time period elapses to at least one lower-panel electrode corresponding to the second region, applying the third driving signal after a third time period elapses to at least one lower-panel electrode corresponding to the third region; and applying a fifth driving signal when a fourth time elapses.

18. The method of claim 17, further comprising:
forming a forward phase slope by applying a first driving signal to at least one lower-panel electrode corresponding to the first region; and
forming a backward phase slope in at least one lower-panel electrode corresponding to the second region by applying the first driving signal to the at least one lower-panel electrode corresponding to the second region, applying the second driving signal after a first time period elapses to the at least one lower-panel electrode corresponding to the second region, and applying a fourth driving signal after a second time period elapses.

19. The driving method of claim 18, wherein
when the second driving signal is applied to the at least one lower-panel electrode corresponding to the second region, a voltage applied to the lower-panel electrode included in a first unit in the second region has a polarity opposite to a polarity of a voltage applied to the lower-panel electrode in a second unit adjacent to the first unit, and
when the fourth driving signal is applied to the at least one lower-panel electrode corresponding to the second region, an absolute value of a fifth voltage applied to the lower-panel electrode in the first unit is greater than an absolute value of a sixth voltage applied to the lower-panel electrode in the second unit.

20. The driving method of claim 17, wherein:
the third region includes a first unit, a second unit adjacent to the first unit, and a third unit adjacent to the second unit, and
when the fourth driving signal is applied to at least one lower-panel electrode corresponding to the third region,
a first voltage applied to the lower-panel electrode in the first unit is greater than a second voltage applied to the lower-panel electrode in the second unit and a third voltage applied to the lower-panel electrode in the third unit.
